(19) United States
(12) Patent Application Publication
(10) Pub. No.: US 2006/0085993 A1
(43) Pub. Date: Apr. 27, 2006

(54) Folding framing square

(76) Inventor: Jerome P. Frankowiak, Brown City, MI (US)

Correspondence Address: GREGORY T. ZALECKI, 12900 HALL ROAD, SUITE 400, STERLING HEIGHTS, MI, 48313, US

(21) Appl. No.: 10/783,602

(22) Filed: Feb. 20, 2004

(51) Int. Cl. B43L 7/10

(52) U.S. Cl. 33/465

(57) ABSTRACT

A folding framing square comprising a body, a tongue and a body extension is disclosed. The tongue and the body extension are pivotally attached to opposite ends of the body. The tongue and the body extension may be folded into a closed position forming a small rectangular easily carryable unit. The tongue and the body extension may also be folded and locked into an open position forming an operative framing square.

### BACKGROUND

A framing square is one of a carpenter's primary tools. It is an L-shaped tool consisting of a body and a tongue joined at right angles. It usually contains calibrations imprinted upon the tongue and the body. It has many carpentry applications. It can be used to lay out straight cutting lines. It is indispensable for making proper angled cuts on roof rafters and stairs stringers.

Typically, the body is 24 inches long and the tongue is 16 inches long. This results in a tool which is large and cumbersome. Carpenters move about often on the job. The traditional framing square is too large and cumbersome to be carried upon the body of the carpenter while the carpenter moves about. As a result, the framing square is often lost and misplaced. It is not unusual for a carpenter to spend significant time away from the carpenter's work area in order to find and retrieve the framing square.

Most carpenters wear nail pouches while working. A nail pouch is a small sack like device which fits around the waist of the carpenter. It is used to carry small tools and other objects, such as nails. The traditional framing square will not fit within a nail pouch because of the size and shape of the framing square.

There is a need for a foldable framing square which would fit within a nail pouch. This would allow the carpenter to always carry a framing square on his or her person while working on projects requiring the use of a framing square. The time and aggravation associated with finding and retrieving a framing square when it is needed would be saved. The foldable framing square would also be easier to store within a toolbox or a bucket because it would fit within those storage devices.

Information relevant to an attempt to address this problem can be found in U.S. Pat. No. 5,669,149. The device described therein will not fit within a nail pouch, many toolboxes or a standard sized bucket. If its dimensions were shortened to allow it to fit within those storage devices, the reduced size would leave it too small for many uses.

### SUMMARY

The present invention is directed to a device that satisfies this need. The device comprises a body, a tongue and a body extension. The body has a tongue end and a body extension end. It has a straight bottom edge. It also has a tongue end side edge and a body extension end side edge. The tongue end side edge is perpendicular to the bottom edge. The body has a channel for receiving the tongue.

The tongue has a straight outer edge. The tongue is shaped to fit within the channel. The tongue is pivotally attached proximal to the tongue end of the body such that the tongue can be pivoted into a closed position substantially recessed within the channel. The pivotal attachment is also adapted to allow the tongue to be pivoted into an open position such that the outer edge of the tongue and the tongue end side edge of the body are collinear. When in the open position the tongue and the body have the configuration of a traditional framing square.

The body extension has a straight bottom edge. The body extension is pivotally attached proximal to the body extension end of the body such that the body extension may be pivoted into an open position. While in such an open position the body extension bottom edge is collinear with the bottom edge of the body. This effectively extends the length of the folding framing square body. The pivotal attachment, the body, the channel and the body extension are also adapted to permit the body extension to be pivoted into a closed position. In the closed position the body extension substantially overlaps the body, as shown in FIG. 3.

An object of the invention is to provide a folding framing square which can be folded into a closed configuration for carrying within a nail pouch. Another object of the invention is to provide a folding framing square which can be unfolded into a fully operative framing square. The folding framing square as described attains these objectives. It can be folded into a compact rectangular unit which easily fits within a nail pouch. It can then be unfolded into an operative framing square.

Preferably, the body has a recess along its top edge. This will facilitate the grasping of the tongue when the tongue is within the channel of the body. The body and the tongue may also have distance calibrations imprinted upon them. The distance calibrations originate or terminate at either the vertex of the bottom edge of the body and outer edge of the tongue, while the tongue is in the open position, or, the vertex of the opposite edges of the body and the tongue, while the tongue is in the open position. Preferably, distance calibrations originate and terminate at both vertices.

Preferably, the folding framing square further comprises a spring loaded ball bearing, an open position body extension detent and a closed position body extension detent. The spring loaded ball bearing is positioned on the body extension end of the body. The open position body extension detent is shaped to receive the ball bearing. This detent is positioned on the body extension such that the body extension may be releasably locked into the open position. While so locked the length of the body of the folding framing square is effectively lengthened. The closed position body extension detent is also shaped to receive the ball bearing. This detent is positioned on the body such that the body extension may be releasably locked into the closed position. While so locked the body extension does not extend the length of the body.

### DRAWINGS

These and other features, aspects, and advantages of the present invention will become better understood with regard to the following description, appended claims, and accompanying drawings where:

FIG. 1 is a perspective view of a folding framing square with the tongue and the body extension locked into an open position.

FIG. 2 is a front view of the folding framing square of FIG. 1 placed upon a workpiece.

FIG. 3 is a front view of the folding framing square of FIG. 1, wherein the tongue and the body extension have been folded into closed positions.

FIG. 4 is a partially broken away view of the folding framing square of FIG. 1 showing a spring forcing a lock into a cutout on the tongue, thereby locking the tongue into the open position.

FIG. 5 is an exploded perspective view of the folding framing square of FIG. 1.

FIG. 6 is a front view of the tongue shown in FIG. 5.

FIG. 7 is a perspective view of the lock and spring shown in FIG. 5.

FIG. 8 is a front view of the bottom face of the body of the folding framing square of FIG. 5.

FIG. 9 is a front view of the spacer of the body of the folding framing square of FIG. 5.

FIG. 10 is a front view of the top face of the body of the folding framing square of FIG. 5.

FIG. 11 is a front view of the body extension of the folding framing square of FIG. 5.

### DESCRIPTION

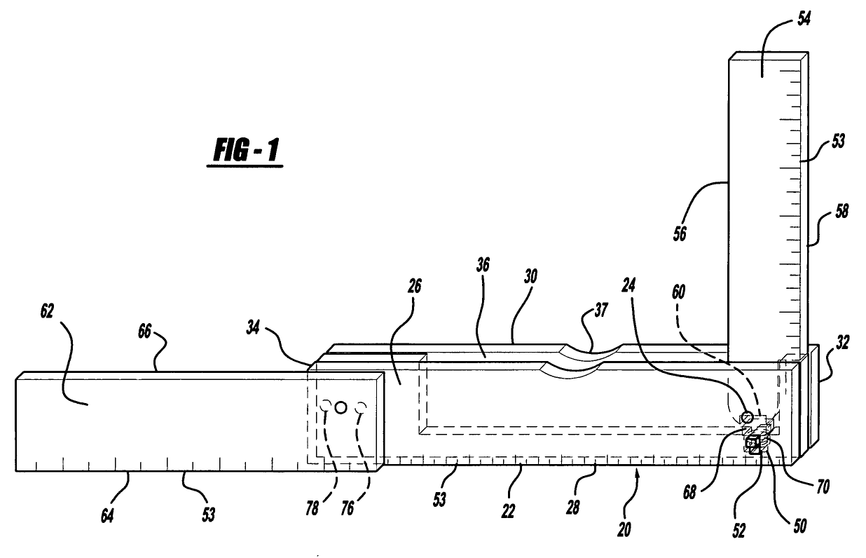

The preferred embodiment of a folding framing square 20 is shown in FIG. 1. This version of the folding framing square 20 is comprised of a body 22, a tongue 54, a body extension 62, a lock 68, a spring 70 and a spring loaded ball bearing 72. The body 22 is fabricated from aluminum. Other materials such as steel and plastic may also be used. The body 22 is rectangular in shape. It has a tongue end 24 and a body extension end 26 on opposing sides. It has a straight bottom edge 28. Preferably, it has a straight top edge 30 which is parallel to the bottom edge 28. A tongue end side edge 32 and a body extension end side edge 34 define two sides of the body 22. The straight bottom edge 28 and the straight top edge 30 define the other two sides of the body 22. The tongue end side edge 32 is perpendicular to the straight bottom edge 28. This allows the tongue end side edge 32 to form a right angle with the straight bottom edge 28 of the body 22, thereby taking the shape of the heel of a traditional framing square. Preferably, the body extension end side edge 34 is also perpendicular to the straight bottom edge 28 of the body 22, thereby facilitating the drawing of cutting lines upon a workpiece with this edge.

The body 22 has a channel 36 for receiving the tongue 54. In order to create the channel 36 the body 22 is comprised of a top face 38, a bottom face 42 and a spacer 46. The top face 38, the bottom face 42 and the spacer 46 are fabricated from aluminum and are rectangular in shape. The top face 38 has a lock guide 40 for receiving the lock 68, as shown in FIG. 10. The bottom face 42 also has a lock guide 44 for receiving the lock 68, as shown in FIG. 10. The spacer 46 has a channel opening 48. The channel opening 48 of the spacer 46 is shaped and sized to receive the tongue 54. The spacer 46 has a lock guide 50 and a spring receptacle 52 for holding the lock 68 and the associated spring 70. The spacer 46 is positioned between the top face 38 and the bottom face 42. The lock guides 40, 44 and 50 of the top face 38, the bottom face 42 and the spacer 46, respectively, are aligned with each other. The top face 38, the spacer 46 and the bottom face 42 are attached together, as shown in FIG. 5, to form the body 22 and channel 36. During the attachment process the tongue 54 should also be pivotally attached to the body as shown in FIG. 5 and as described below. Suitable fasteners such as rivets are used to attach the top face 38, the bottom face 42 and the spacer together.

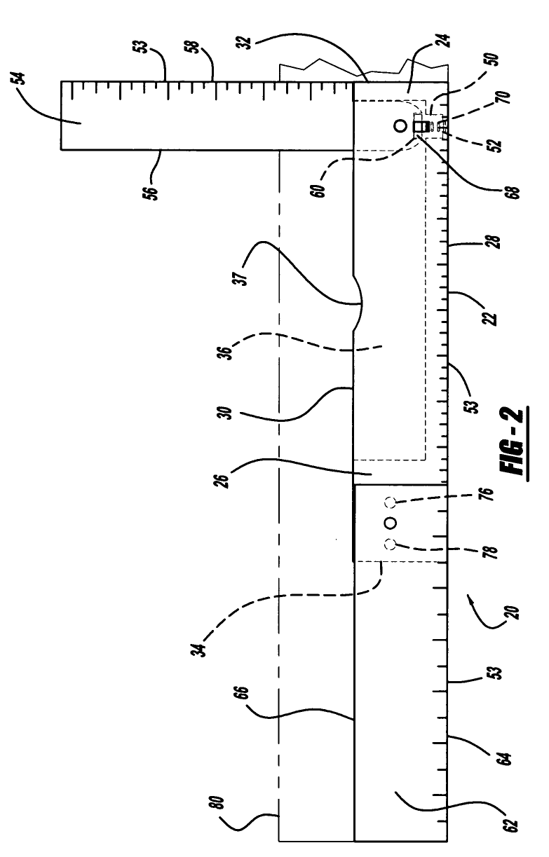

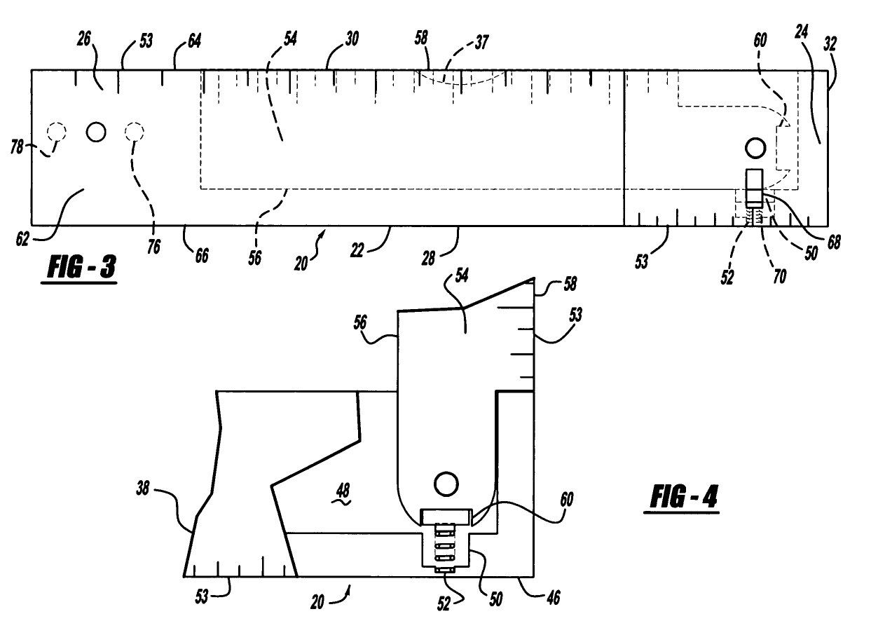

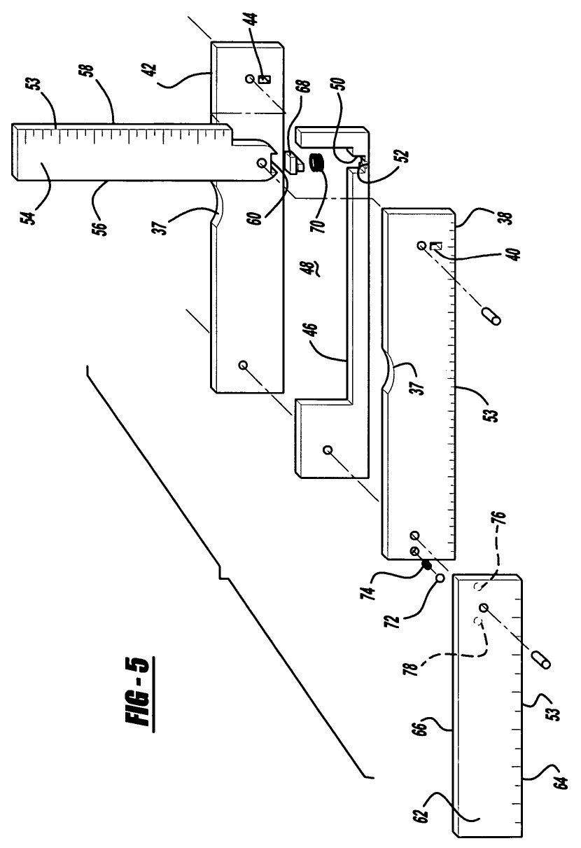

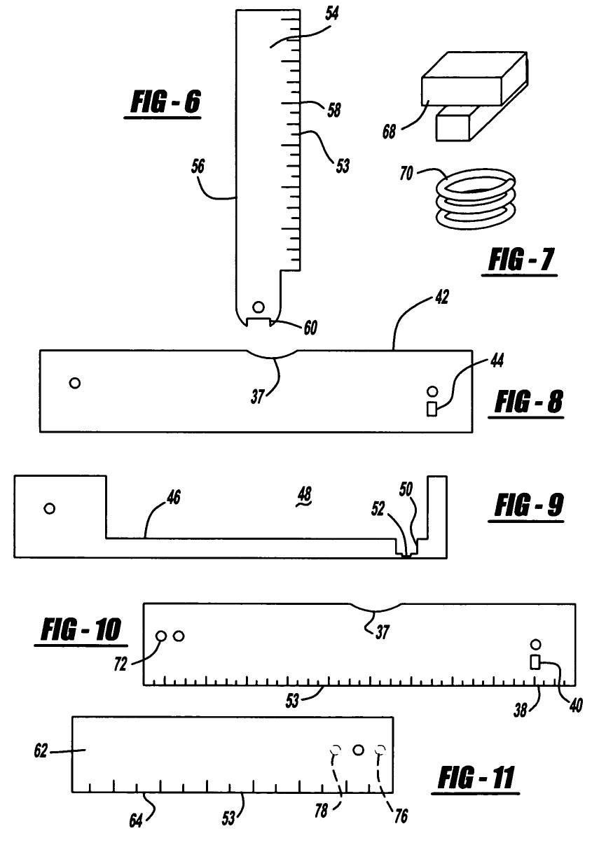

The tongue 54 is rectangular in shape and has a straight outer edge 58. It is fabricated from the same material as the body 22. Preferably, it also has a straight inner edge 56 which is parallel to the straight outer edge 58 of the tongue 54. This will permit the inner edge 56 of the tongue 54 and the straight top edge 30 of the body 22 to form a right angle, thereby allowing these edges to function as the corresponding edges of a traditional framing square. The tongue 54 is shaped to fit within the channel 36 of the body 22. The tongue 54 is pivotally attached, as shown in FIG. 5, to the tongue end 24 of the body 22 such that the tongue 54 can be pivoted into a closed position or an open position. In the closed position the tongue 54 is substantially recessed within the channel 36 as shown in FIG. 3. In the open position the straight outer edge 58 of the tongue 54 and the tongue end side edge 24 of the body 22 are collinear, as shown in FIG. 2. In this open position the tongue 54 and the body 22 are configured as a framing square. The tongue 54 has a cutout 60 at its pivotally attached end for receiving the lock 68. The tongue 54 is pivotally attached to the tongue end 24 of the body 22 with a suitable fastener such as a rivet, a pivot pin or a Chicago screw.

The body extension 62 is fabricated from the same material as the body 22. It has a straight bottom edge 64. Preferably, it has a straight top edge 66 and has the same width dimension as the body 22. Thus, it would be capable of linearly extending both the straight bottom edge 28 and the straight top edge 30 of the body 22. The body extension 62 is pivotally attached proximal to the body extension end 26 of the body 22, as shown in FIG. 5, such that the body extension 62 may be pivoted into an open position or into a closed position. In the open position the body extension bottom edge 64 is collinear with the bottom edge 28 of the body 22, as shown in FIG. 2, thereby effectively extending the body length of the folding framing square 20. In the closed position the body extension 62 substantially overlaps the body 22, as shown in FIG. 3. When the tongue 54 and the body extension 62 are folded into closed configurations, as shown in FIG. 3, the folded framing square may be easily carried within a nail pouch or placed within a toolbox. When the tongue 54 and the body extension 62 are folded into open configurations, a shown in FIG. 2, the unfolded framing square 20 functions as an operative framing square. The body extension 62 is pivotally attached to the body extension end 26 of the body 22 with a suitable fastener such as a rivet, a pivot pin or a Chicago screw.

The lock 68 is shaped to fit within the cutout 60 of the tongue 54. It is positioned within the lock guides 40, 44, 50 of the body 22. The spring 70 is positioned within the lock receptacle 52 of the body 22 below the lock 68 such that the spring 70 will force the lock 68 into the cutout 60 of the tongue 54 when the tongue 54 and the body 22 are perpendicular. When the tongue 54 and the body 22 are locked into a perpendicular position the tongue 54 and the body 22 function as an operative framing square. The tongue 54 may be unlocked from the body 22 by depressing the lock 68, thereby freeing the tongue 54 for pivotal movement about its attachment point to the body 22.

In order to allow the body extension 62 to be locked into an open position or into a closed position a spring loaded ball bearing 72 is positioned on the body 22 and two detents 76, 78 are formed onto the body extension 62. The spring loaded ball bearing 72 is positioned on the body extension end 26 of the body 22, facing the body extension 62. The spring loaded ball bearing 72 is forced outward from the body 22 by a ball bearing spring 74. An open position body extension detent 78 is shaped to receive the spring loaded ball bearing 72 and is positioned on the body extension 62 such that the body extension may be releasably locked into the open position by the spring loaded ball bearing 72. A closed position body extension detent 76 is shaped to receive the spring loaded ball bearing 72 and is positioned on the body extension 62 such that the body extension 62 may be releasably locked into the closed position by the spring loaded ball bearing 72.

Preferably, the body 22 has a recess 37 centered along its top edge 30. The recess 37 facilitates the grasping of the tongue 54 when the tongue 54 is within the channel 36 of the body 22, thus making it easier to move the tongue 54 from the closed position to the open position. The body 22 and the tongue 54 may also have distance calibrations 53 imprinted upon them. The distance calibrations 53 originate or terminate at either the vertex of the bottom edge 28 of the body 22 and outer edge 58 of the tongue, while the tongue 54 is in the open position, or, the vertex of the opposite edges 30, 56 of the body 22 and tongue 54, while the tongue 54 is in the open position. The distance calibrations 53 may originate and terminate at both vertices. The distance calibrations 53 facilitate laying out straight measured cutting lines and making proper angled cuts on roof rafters and stairs stringers.

When it is desired to store or carry the folding framing square 20, the tongue 54 is folded into the closed position into the channel 36 of the body 22, as shown in FIG. 3. The tongue 54 may be unlocked by depressing the lock 68. The body extension 62 is folded into the locked position such that the body extension 62 does not extend the length of the body 22, as shown in FIG. 3. A small manual force will be required to release the spring loaded ball bearing 72 from the open position body extension detent 78.

When it is desired to use the folding framing square 20, the tongue 54 is locked into the open position perpendicular to the body 22 and the body extension 62 is locked into the open position, such that the straight bottom edge 64 of the body extension 62 is collinear with the straight bottom edge 28 of the body 22, as shown in FIG. 1. The tongue 54 may be easily pivoted out of the channel 36 by grasping the tongue 54 at the recess 37 of the body 22. When the tongue 54 is moved into a position perpendicular to the body 22, the spring 70 will force the lock 68 into the cutout 60 of the tongue 54, thereby locking the tongue 54 perpendicular to the body 22 forming an operative framing square. If the body extension 62 is locked in the closed position a small manual force will release the closed position body extension detent 76 from the spring loaded ball bearing 72, thereby permitting the body extension to be rotated into the open position, as shown in FIG. 1. When the body extension 62 reaches the open position the spring loaded ball bearing will enter the open position body extension detent 78 and lock the body extension 62 such that it extends the length of the body 22.

When the tongue 54 is locked into the open position the folding framing square 20 functions as an operative framing square. It may be placed upon a workpiece 80 for drawing straight lines thereon, as shown in FIG. 2. It may also be used to perform all other functions performed by a traditional framing square.

The primary advantage of the folding framing square is that it may be folded into a small compact unit which will easily fit within a carpenter's nail pouch, a toolbox, a bucket or other container. Thus a carpenter can easily carry the folded framing square on his or her person while moving about the workplace. When a job requires the use of a framing square, the folded framing square may be unfolded and used as a fully operative framing square.

Although the invention has been shown and described with reference to certain preferred embodiments, those skilled in the art undoubtedly will find alternative embodiments obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A folding framing square comprising:
(a) a body having a tongue end, a body extension end, a straight bottom edge, a tongue end side edge, a body extension end side edge, the tongue end side edge being perpendicular to the bottom edge, and a channel;
(b) a tongue having a straight outer edge, said tongue being shaped to fit within the channel, said tongue being pivotally attached proximal to the tongue end of the body such that the tongue can be pivoted into a closed position substantially recessed within the channel and can also be pivoted into an open position such that the outer edge of the tongue and the tongue end side edge of the body are collinear; and
(c) a body extension having a straight bottom edge, the body extension being pivotally attached proximal to the body extension end of the body such that the body extension may be pivoted into an open position wherein the body extension bottom edge is collinear with the bottom edge of the body and the body extension may be pivoted into a closed position wherein the body extension substantially overlaps the body, whereby the folding framing square can be folded into a closed configuration for carrying within a nail pouch and can be unfolded into an operative framing square.

2. The folding framing square of claim 1 wherein the body has a recess along its top edge for facilitating the grasping of the tongue when the tongue is within the channel of the body.

3. The folding framing square of claim 1 further comprising distance calibrations imprinted thereon.

4. The folding framing square of claim 2 further comprising distance calibrations imprinted thereon.

5. The folding framing square of claim 1 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position.

6. The folding framing square of claim 2 further comprising:
(a) a spring loaded ball bearing positioned on the body extension end of the body;
(b) an open position body extension detent, shaped to receive the ball bearing, positioned on the body extension such that the body extension may be releasably locked into the open position; and
(c) a closed position body extension detent, shaped to receive the ball bearing, positioned on the body extension such that the body extension may be releasably locked into the closed position by the spring loaded ball bearing.

7. The folding framing square of claim 3 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position by the spring loaded ball bearing.

8. The folding framing square of claim 4 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position by the spring loaded ball bearing.

9. A folding framing square comprising:
(a) a body having a tongue end, a body extension end, a straight bottom edge, a tongue end side edge, a body extension end side edge, the tongue end side edge being perpendicular to the bottom edge, and a channel, said body comprising a top face having a lock guide, a bottom face having a lock guide, a spacer having a channel opening, a lock guide and a spring receptacle, said spacer being between the top face and the bottom face and said spacer being attached to the top face and the bottom face, said lock guides being in alignment with each other;
(b) a tongue having a straight outer edge, said tongue being shaped to fit within the channel, said tongue being pivotally attached proximal to the tongue end of the body such that the tongue can be pivoted into a closed position substantially recessed within the channel and can also be pivoted into an open position such that the outer edge of the tongue and the tongue end side edge of the body are collinear, said tongue having a cutout at its pivotally attached end for receiving a lock;
(c) a body extension having a straight bottom edge, the body extension being pivotally attached proximal to the body extension end of the body such that the body extension may be pivoted into an open position wherein the body extension bottom edge is collinear with the bottom edge of the body and the body extension may be pivoted into a closed position wherein the body extension substantially overlaps the body, whereby the folding framing square can be folded into a closed configuration for carrying within a nail pouch and can be unfolded into an operative framing square;
(d) a lock, shaped to fit within the cutout of the tongue, positioned within the lock guides; and
(e) a spring positioned within the lock receptacle below the lock such that the spring will force the lock into the cutout of the tongue when the tongue and the body are perpendicular.

10. The folding framing square of claim 9 wherein the body has a recess along its top edge for facilitating the grasping of the tongue when the tongue is within the channel of the body.

11. The folding framing square of claim 9 further comprising distance calibrations imprinted thereon.

12. The folding framing square of claim 10 further comprising distance calibrations imprinted thereon.

13. The folding framing square of claim 9 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position by the spring loaded ball bearing.

14. The folding framing square of claim 10 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position by the spring loaded ball bearing.

15. The folding framing square of claim 11 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position by the spring loaded ball bearing.

16. The folding framing square of claim 12 further comprising:
(a) a spring loaded ball bearing positioned on the body extension end of the body;
(b) an open position body extension detent, shaped to receive the ball bearing, positioned on the body extension such that the body extension may be releasably locked into the open position by the spring loaded ball bearing; and
(c) a closed position body extension detent, shaped to receive the ball bearing, positioned on the body extension such that the body extension may be releasably locked into the closed position by the spring loaded ball bearing.
